(19) United States
(12) Patent Application Publication
(10) Pub. No.: US 2007/0282947 A1
(43) Pub. Date: Dec. 6, 2007

(54) METHOD AND SYSTEM FOR PROVIDING SIMULTANEOUS AWARENESS ACROSS MULTIPLE TEAM SPACES IN REAL TIME

(76) Inventors: Susanne Hupfer, Lexington, MA (US); Steven Ross, South Hamilton, MA (US); John Patterson, Carlisle, MA (US)

Correspondence Address: LOTUS AND RATIONAL SOFTWARE;McGuinness & Manaras LLP, 125 NAGOG PARK, ACTON, MA, 01720, US

(21) Appl. No.: 11/421,422

(22) Filed: May 31, 2006

(51) Int. Cl. G06F 9/00

(52) U.S. Cl. 709/204; 715/753; 715/751; 715/733

(57) ABSTRACT

A system in which awareness information about multiple team rooms to which a user belongs is simultaneously made available in real time through a team member's team room user interface, including visual representations of all the team rooms to which the user belongs, and where the visual representations of the team rooms to which the user belongs are modified in real time to indicate whether any team room members are currently present in each team room. Visual indication of various details about the current state of each team room may further be made available through a hover over “tooltip” or other graphical user interface element. Visual indications of specific team room details may also be provided directly on or as part of the display objects representing the team rooms to which the user belongs. Team room icons may be modified with various specific visual indicators, giving the user abstracted detail information regarding the team rooms.

### FIELD OF THE INVENTION

The present invention relates generally to computer supported collaborative work, and more specifically to a method and system for providing simultaneous awareness across multiple team spaces in real time.

### BACKGROUND OF THE INVENTION

Team room software is becoming increasingly popular as a tool for information sharing and collaboration among members of teams. Existing team room systems, such as Lotus QuickPlace, IBM® Workplace Team Collaboration™ team spaces, Groove Workspace, Documentum eRoom, and Microsoft SharePoint Team Services, allow for the creation of virtual project team shared “areas” or “workspaces” that support team communication, coordination, and collaboration. These shared work spaces typically give team members a centralized place where they can store, organize, and retrieve resources relating to the team's project, e.g. code files, designs, project documentation, presentations, schedules, and sometimes applications. In addition, team rooms typically support interactive discussion among members, allowing them to chat or otherwise communicate about a project, and solve project issues.

In many cases a user may be a contributor to multiple projects, each of which has an associated team room. Each of these team rooms can accumulate artifacts and host discussions among team members, but they may each do so at a different pace. One team room representing a very active project might accumulate hundreds of new documents per day and host dozens of on-line discussions among a large number of participating teammates, while another less-active team room may have just one new (or modified) document every week and host only very occasional discussions among a handful of members. In existing systems, there is no easy way for a member of multiple team rooms to have an awareness of what has happened within those multiple team rooms since they last visited each of them, or to have an awareness of what is currently happening within them, without re-visiting each of them in turn. Revisiting each team room individually may be a time-consuming exercise, and may also be a waste of time if not much of interest has happened in many of the team rooms being visited. If team members choose to visit their team rooms less frequently, assuming that nothing significant happens very often, they run the risk of missing important information when it gets created or changes. A lack of response to the posting of information in a team room tends to serve as a disincentive for further postings, resulting in a negative feedback cycle that may lead to a team room becoming inactive.

Existing team room systems have sometimes offered minimal awareness of changes that have occurred within specific team rooms. Some (e.g. Lotus® QuickPlace) support sending periodic (e.g. daily or weekly) electronic mail (“email”) notices to team members, informing them of new documents that have been added. Some others permit team rooms to publish RSS (“RDF Site Summary”) feeds that will inform team members of “What's New” within a team room. One problem with these existing solutions is that the notifications they provide are not very immediate. Since both email and RSS are polling-based technologies, team members will at best only see what's new in individual team rooms when they check their email or read their RSS feeds. Since these existing technologies are not real-time, they don't offer a way to tell the user what is happening “right now” within each team room. For multiple team rooms, existing systems do not enable a user to conveniently maintain awareness of various types of up-to-the-minute information.

Another problem with some existing systems solutions is that they may deliver too much information about changes that are not that relevant to a particular user, so information about pertinent and relatively important changes may get lost in the flood. Additionally, users stop paying attention to periodic automatic emails when the information they convey is usually not relevant to them, and thus may miss the occasional messages that do contain relevant information.

For the above reasons and others it would be desirable to have a new system for providing simultaneous awareness of information regarding the current state of multiple team rooms to a member of those team rooms.

### SUMMARY OF THE INVENTION

To address the above described and other shortcomings of previous solutions, a system is disclosed that provides an awareness mechanism and user interface for users to have synchronous awareness of what is happening in the team rooms to which they belong. In the disclosed system, awareness information about multiple team rooms to which a user belongs is simultaneously made available in real time through a team member's team room user interface, including visual representations of all the team rooms to which the user belongs, where the visual representations are modified in real time to indicate whether any team room members are currently present in each team room.

Visual indication of various details about the current state of each team room may further be made available through a hover over “tooltip” or other graphical user interface element. Such specific details may include how many team room members are present in each team room, how many new documents there are in each team room and how many of them are of particular importance to this user, how many modified documents there are in each team room and how many of them are of particular importance to this user, what on-line discussions or other synchronous interactions are currently taking place, what tasks members are currently engaged in, and the like.

Visual indications of specific team room details may also be provided directly on or as part of the display objects representing the team rooms to which the user belongs. Team room icons may be modified with various specific visual indicators, giving the user abstracted detail information regarding the team rooms, without requiring the user to hover the cursor in order to see a tooltip. In one embodiment, team room icons are modified in real time using “thermometer” bars to denote how many important new/changed artifacts and tasks the space currently has, versus how many not-as-important new/changed artifacts and tasks the space currently has. Additional such visual indicators may be used to visually represent the percentage of team room members that are currently present in the team room.

The disclosed system advantageously provides a mechanism and user interface for providing users with at-a-glance information regarding their team rooms, thus conveniently maintaining a real-time awareness of what is happening within each team room to which the user belongs. Moreover, the disclosed system displays changes that are relevant/important to a user in a visually distinct way with respect to less-relevant information. The awareness information can accordingly better guide the user's decisions about which team rooms to visit when and how frequently, and can help to keep team rooms active and relevant.

Thus there is disclosed a new system for providing simultaneous awareness of information regarding the current state of multiple team rooms to a member of those team rooms.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a block diagram showing hardware and software components in an execution environment including an illustrative embodiment of the disclosed system;

FIG. 2 is a screen shot illustrating a team room application user interface generated by an embodiment of the disclosed system to simultaneously provide a view of awareness information regarding multiple team rooms to a member of those multiple team rooms;

FIG. 3 is a portion of a screen shot illustrating a portion of a team room application user interface in an alternative embodiment; and

FIG. 4 is a flow chart illustrating steps performed in an embodiment of the disclosed system.

### DETAILED DESCRIPTION OF EXEMPLARY EMBODIMENTS

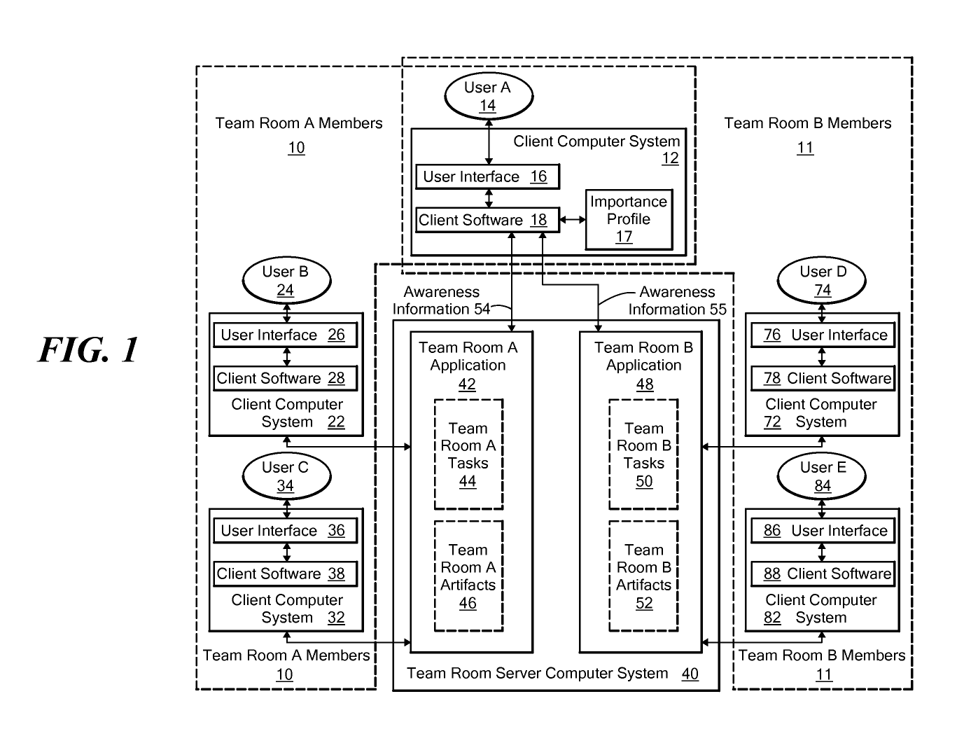

FIG. 1 is a block diagram showing hardware and software components in an execution environment for an illustrative embodiment of the disclosed system. As shown in FIG. 1, the members 10 of a Team Room A include a User A 14, a User B, 24, and a User C 34. User A 14 is provided a User Interface 16 on Client Computer System 12 by Client Software 18, User B 24 is provided a User Interface 26 on Client Computer System 22 by Client Software 28, and User C 34 is provided a User Interface 36 on Client Computer System 32 by Client Software 38. The members 11 of Team Room B are shown including User A 14, User D 74 and User E 84. User D 74 is provided a User Interface 76 on Client Computer System 72 by Client Software 78, and User E 84 is provided User Interface 86 on Client Computer System 82 by Client Software 88. FIG. 1 illustrates that User A 14 is a member of multiple team rooms, shown for purposes of illustration as Team Room A and Team Room B.

Team Room A Application 42 and Team Room B Application 48 provide team rooms that are virtual, shared “areas” or “workspaces” that support communication, coordination, and collaboration between their respective team members. Specifically, Team Room A Application 42 creates a virtual workspace that is shared by members 10 of Team Room A, and Team Room B Application creates a virtual workspace that is shared by the members 11 of Team Room B. Team Room A Application 42 enables the members 10 of Team Room A to store, organize, and retrieve Team Room resources, such as Team Room A Artifacts 46, which may be related to a team project for which the members 10 of Team Room A are responsible. Team Room A Application 42 controls the Artifacts 46 and other Team Room resources such that accesses to and/or other operations on them can by default only be performed by the members 10 of Team Room A. Team A Artifacts 46 may include any specific type of information, for example, code files, designs, project documentation, presentations, schedules, and/or application programs. Team Room A Application 42 further provides interactive discussion among members 10, for example through an instant messaging and/or any other specific type of communication application.

Similarly, Team Room B Application creates a virtual workspace that is shared by members 11 of Team Room B, and Team Room B Application 48 creates a virtual workspace that is shared by the members 11 of Team Room B. Team Room B Application 48 enables the members 11 of Team Room B to store, organize, and retrieve Team Room resources, such as Team Room B Artifacts 52, which may be related to a team project for which the members 11 of Team Room B are responsible. Team Room B Application 48 controls the Artifacts 52 and other Team Room resources such that accesses to and/or other operations on them can by default only be performed by the members 11 of Team Room B. Team Room B Artifacts 52 may include any specific type of information, for example, code files, designs, project documentation, presentations, schedules, and/or application programs. Team Room B Application 48 further provides interactive discussion among members 11, for example through an instant messaging and/or any other specific type of communication application.

Team Room A Tasks 44 are tasks that the Team Room A Members 10 have planned, are engaged in, and/or have completed, and are maintained by the Team Room A Application 42 for the purpose of enhancing cross-team awareness and coordination. Each of the tasks stored in the Tasks 44 indicates or contains task-related information such as: which of the Team Room Team Members 10 are assigned to the task, the status of the task (e.g. completed, planned, or underway), a priority associated with the task (e.g. high priority or low priority), a description of the task, and which of the Team Room A Artifacts 46 are associated with the task. Team Room A Tasks 44 are also examples of the resources of Team Room A.

Team Room B Tasks 50 are tasks that the Team Room B Members 11 have planned, are engaged in, and/or have completed, and are maintained by the Team Room B Application 48 for the purpose of enhancing cross-team awareness and coordination. Each of the tasks stored in the Tasks 50 indicates or contains task-related information such as: which of the Team Room Team Members 11 are assigned to the task, the status of the task (e.g. completed, planned, or underway), a priority associated with the task (e.g. high priority or low priority), a description of the task, and which of the Team Room B Artifacts 52 are associated with the task. Team Room B Tasks 50 are also examples of the resources of Team Room B.

While FIG. 1 shows Team Room A Tasks 44 and Team Room A Artifacts 46 as examples of resources of Team Room A, and Team Room B Tasks 50 and Team Room B Artifacts 52 as examples of resources of Team Room B, the disclosed system is not so limited. Accordingly, the disclosed system may be embodied using any specific type of team room resource in addition or in the alternative.

A member of a Team Room is considered to be “present” in that Team Room if that member navigated to the Team Room, for example through a menu structure or other user interface construct. In this way the member is said to have “entered” the Team Room. Presence in a Team Room involves having the client software for the Team Room currently executing on the member's client computer system, such that the user interface for that Team Room is being generated and displayed to the member on the member's client computer system. Additionally, when a Team Room member is present in a Team Room they are available to immediately participate in on-line discussions or other real time, synchronous communications related to the resources, such as artifacts, tasks, etc., of the Team Room. For example, a Team Room member that is present in a Team Room is available to receive instant messages in the Team Room user interface, from other Team Room members, regarding the contents of the Team Room. Since access to Team Rooms is restricted, a Team Room member must typically logon to a Team Room application program in order to become present in an associated Team Room. Such a logon procedure may include providing a user name and password, or following some other appropriate logon procedure. Once a person has entered a Team Room, they are considered present until they navigate away from the Team Room, thus “leaving” the team room. Leaving a Team Room may, for example, involve logging off of the Team Room application program, closing the client software program or user interface through which they access the Team Room, entering another Team Room, or some other appropriate procedure. In one embodiment of the disclosed system, a user may only be present in one Team Room at a time.

The client computer systems 12, 22, 32, 72 and 82 of FIG. 1 are communicably connected to a Team Room Server Computer System 40, for example by way of a communication network such as the Internet, a Local Area Network (LAN), or other specific type of communication network. The client software 28 and 38 communicates with the Team Room A Application program 42 to provide the respective user interfaces 26 and 36. Similarly, the client software 78 and 88 communicates with the Team Room B Application program 48 to provide the respective user interfaces 76 and 86. The client software 18 communicates with both Team Room A Application program 42 and Team Room B Application program 48 to provide the user interface 16. The communications between the client software 18 and the Team Room A Application program 42 and the Team Room B Application program 48 include Awareness Information 54 and 55.

The Awareness Information 54 conveyed from the Team Room A Application program 42 includes information indicating whether any team room members of Team Room A are currently present in Team Room A, and/or how many team room members of Team Room A are currently present in Team Room A. The awareness information 55 conveyed from the Team Room B Application program 48 includes information indicating whether any team room members of Team Room B are currently present in Team Room B, and/or how many team room members of Team Room B are currently present in Team Room B.

The Awareness Information 54 conveyed from Team Room A Application program 42 to the Client Software 18 may further include indication of how many new documents there are in Team Room A, and/or the names of such new documents, where new documents include those documents created in Team Room A since the last time User A 14 left Team Room A, and/or those documents contained in Team Room A that User A 14 has never accessed. Similarly, the Awareness Information 54 conveyed from Team Room A Application program 42 to the Client Software 18 may further include indication of how many modified documents there are in Team Room A, and/or the names of such modified documents, where modified documents may include those documents modified in Team Room A since the last time User A 14 left Team Room A, and/or those documents contained in Team Room A that User A 14 has not accessed since they were modified.

The Awareness Information 55 conveyed from Team Room B Application program 48 to the Client Software 18 may further include indication of how many new documents there are in Team Room B, and/or the names of such new documents, where new documents may include those documents created in Team Room B since the last time User A 14 left Team Room B. Similarly, the Awareness Information 55 conveyed from Team Room B Application program 48 to the Client Software 18 may further include indication of how many modified documents there are in Team Room B, and/or the names of such modified documents, where modified documents may include those documents modified in Team Room B since the last time User A 14 left Team Room B.

The Awareness Information 54 conveyed from the Team Room A Application program 42 may further include information indicating whether any on-line discussions or other synchronous interactions are currently taking place between Team Room A members, and/or indications of what Team Room A tasks members of Team Room A are currently engaged in. The awareness information 55 conveyed from the Team Room B Application program 48 may similarly include information indicating whether any on-line discussions or other synchronous interactions are currently taking place between Team Room B members, and/or indications of what Team Room B tasks members of Team Room B are currently engaged in.

Client software 18 provides the User Interface 16 responsive to the Awareness Information 54, the Awareness Information 55, and an Importance Profile 17. The Importance Profile 17 contains information indicating the importance of various Team Room resources to User A 14. In one embodiment, the relative importance of a Team Room resource is determined based on whether that resource is associated with a task to which the user is assigned. Accordingly, in such an embodiment, a resource may be determined to be relatively more important to a given user than other resources in the event that the resource is associated with a task to which that user is assigned. In another embodiment, the importance of a given document to a user may be determined based on whether the user authored or modified the document, such that those documents that were authored or modified by a user are determined to be relatively more important to that user than other documents.

Alternatively, the Importance Profile 17 may be used to record the number of times User A 14 has accessed a document contained in Team Room A, and based on that number, the Client Software 18 may determine whether that document is important to User A 14. Documents that have been accessed more often than other documents may be considered relatively more important. This approach to importance determination based on frequency of access may further be applied to any specific type of resource within a Team Room. In another alternative approach, a user may expressly provide indications of which resources within a Team Room are to be considered relatively important, for example through the User Interface 16, and these indications may be stored in the Importance Profile 17.

While the Importance Profile 17 is shown for purposes of illustration as being located on the Client Computer System 12, the disclosed system may be alternatively embodied such that the Importance Profile 17 is stored partly or wholly on the Team Room Computer Server System 40. Moreover, while for purposes of concise and clear illustration only the Importance Profile 17 for User A 14 is shown in FIG. 1, each of the other users 24, 34, 74 and 84 may similarly have an importance profile associated with and maintained for them, stored for example either on their respective client computer systems, and/or on the Team Room Computer Server System 40.

Client software 18, 28, 38, 78 and 88 may, for example, use a client-server approach to operating with the server software 42 and 48. Alternatively, the client software 18, 28, 38, 68, 78 and 88 may include Web browser program functionality operable to request and receive Web page content, including HTML (Hypertext Markup Language) code or the like, from their respective Team Room applications, and to render such Web page content in their respective user interfaces.

The client computer systems 12, 22, 32, 72 and 82, and Team Room Server Computer System 40, may each include at least one processor, program storage, such as memory, for storing program code executable on the processor, and one or more input/output devices and/or interfaces, such as data communication and/or peripheral devices and/or interfaces. The client computer systems 12, 22, 32, 72 and 82, and the Team Room Server Computer System 40 may each further include appropriate operating system software. The client computer systems 12, 22, 32, 72 and 82 may further include portions of an integrated development environment (IDE), such as the Eclipse IDE as provided by the Eclipse Foundation.

While for purposes of clear illustration and concise explanation FIG. 1 shows only three members of Team Room A and three members of Team Room B, and one Team Room Server Computer System 40, the disclosed system is not so limited, and those skilled in the art will recognize that there may be multiple other client and/or server computer systems in an operational environment of an embodiment of the disclosed system, and that any specific number of users may be members of a given team room at a given time. While only two team rooms are shown in FIG. 1, the disclosed system is applicable to configurations or deployments having any specific number of team rooms. Moreover, while the User A 14 is shown belonging to two Team Rooms in the example of FIG. 1, the disclosed system may be embodied such that a user can simultaneously be a member of much larger numbers of Team Rooms, and to receive awareness information from all such Team Rooms.

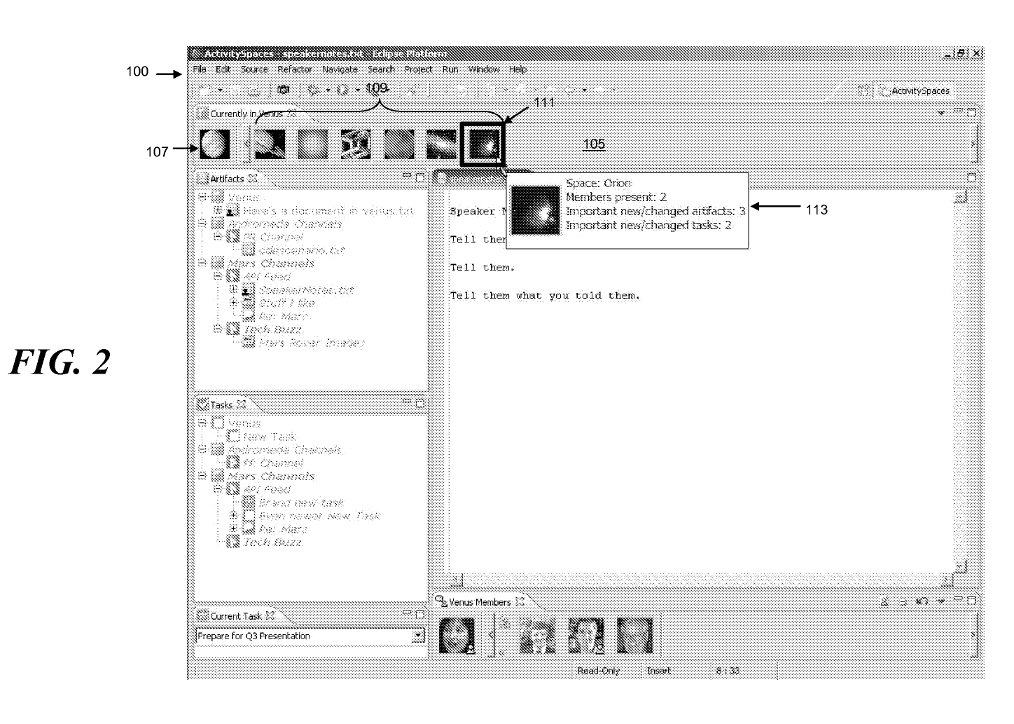

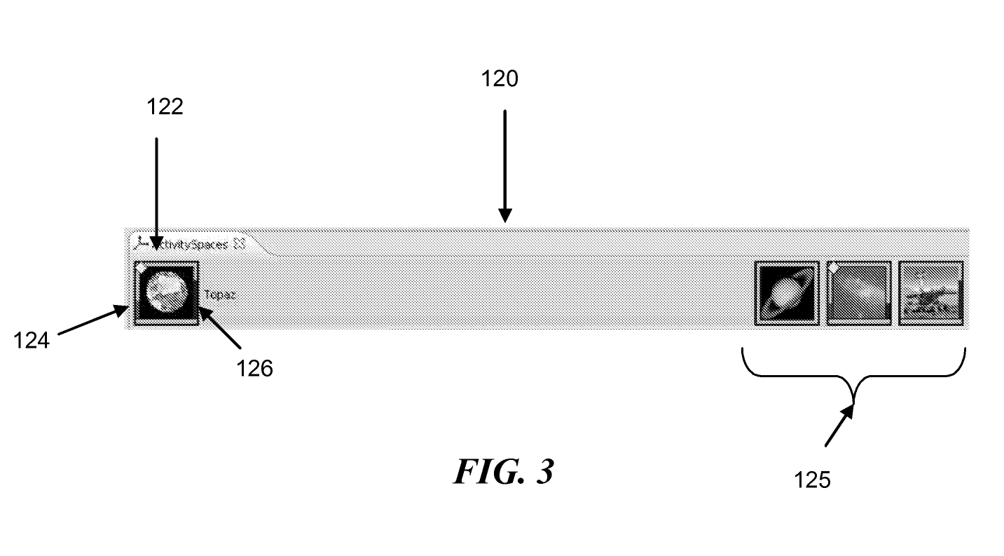

In the following explanatory discussion, with regard to FIGS. 2 and 3, an embodiment is described in which Team Rooms are sometimes referred to as “spaces”. FIG. 2 shows a screenshot of a user interface 100 provided by an embodiment of the disclosed system to a member of multiple spaces, and corresponding to a Team Room user interface such as the User Interface 16 of FIG. 1. In the user interface 100 of FIG. 2, the user is currently working in, and therefore present in, the “Venus” space. The space bar 105 user interface component is a portion of the user interface 100 that includes visual representations of all spaces to which the user belongs. As shown in FIG. 2, for example, the space bar 105 includes a visual representation 107 of the Venus space in which the user is currently present, as well as visual representations 109 of those other spaces in which the user is a member, but in which the user is not currently present. Within the visual representations 109, a visual representation 111 is displayed in a visually distinct way that indicates that at least one member of the corresponding space (“Orion”) is currently present. In the example of FIG. 2, the visual representation 111 has been surrounded by a black square, but the invention is not limited to such an approach. In another embodiment, those of the visual representations 109 corresponding to spaces in which at least one member is present are displayed in color, while those of the visual representations 109 corresponding spaces in which no members are present are displayed in grey scale. Any other specific type of visual presentation may be used to create a visual distinction between visual representations of spaces in which no members are present, and visual representations of spaces in which at least one member is present, in the space bar 105.

The disclosed system includes an underlying notification mechanism that lets the client software that creates the user interface 100 know immediately of any changes to spaces as they occur, as illustrated in FIG. 1 by the Awareness Information 54 and 55. Accordingly, the changes in the visual representations of spaces in the space bar 105 happen in real-time. As soon as a member enters a previously empty space, the visual representation or icon for that space is changed, for example from grayscale to color. Conversely, in such an embodiment, once the last member leaves a space, the visual representation for that space in the space bar 105 turns back to grayscale. In this way, the disclosed system maintains a user interface that provides “presence awareness” for each space to which the user belongs, reflecting whether any members are present in each space or not.

As further shown in FIG. 2, a user interface element 113 is also generated in the user interface 100 to provide further details about the current activities in a space, for example the Orion space represented by the visual representation 111 in the space bar 105. In the example of FIG. 2, the user element 113 is generated in response to the user hovering the cursor over the visual representation 111, and is shown as what is sometimes referred to as a “tooltip”. The user can hover the cursor over any of the space visual representations in the space bar 105 in order to obtain more detailed information about what is happening in the corresponding space via a tooltip.

The detail information provided in the tooltip 113 shown in FIG. 2 may include any specific kind of information regarding the current state of the Orion space. For example, the tooltip 113 of FIG. 2 indicates how many team members are currently working in the space, how many new or changed artifacts there are in the space that are important to the user, and how many new or changed tasks there are in the space that are important to the user. Other examples of detail information that may be provided through the tooltip 113 or another graphical user interface element associated with one of the space visual representations in the space bar 105 include the total number of new artifacts in the space, the total number of changed artifacts in the space, the total number of new tasks in the space, the total number of changed tasks in the space, the number of real-time discussions (or other real-time interactions) currently taking place within the space and who is participating in them, and/or what tasks the members who are present are engaged in.

FIG. 3 shows a space bar 120 provided by an alternative embodiment of the disclosed system. A visual representation 122 of the current Topaz space, and visual representations 125 of other spaces to which the user belongs, are included in the space bar 120. As shown in FIG. 3, detail information regarding the spaces represented in the space bar 120 may be made visible by generating visual indicators directly on the visual representations of the spaces. For example, the visual representation 122 of the current Topaz space also includes a visual indicator 124 that is a “thermometer” bar having a length representing the number of important new and/or changed artifacts and tasks within the Topaz space. Another visual indicator 126 is a thermometer bar whose length represents the number of not-as-important new/changed artifacts and tasks the Topaz space currently has. In one embodiment, the visual indicator 124 is provided in a first color, such as red, and the other visual indicator is provided in a second color, such as blue, in order for the relative number of important new and/or changed artifacts and tasks to be quickly apparent with respect to the number of not-as-important new and/or changed artifacts and tasks in the space. Such visual indicators as 124 and 126 may also or alternatively be used to represent other details regarding the spaces corresponding to the visual representations of the spaces, such as the number of members that are present in the corresponding space. For example, the length of such a thermometer bar as 124 or 126 could be used to represent the number of members currently present in the corresponding space.

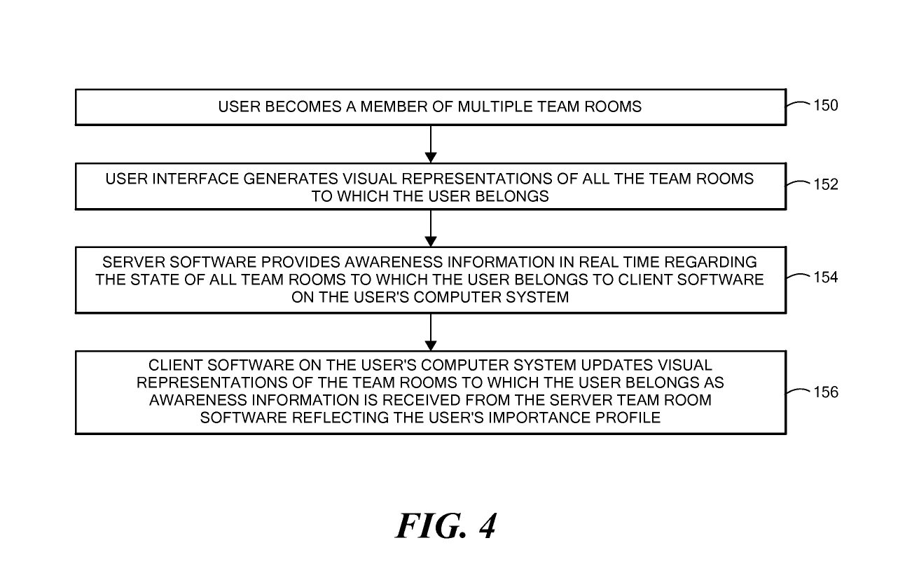

FIG. 4 is a flow chart illustrating steps performed in an embodiment of the disclosed system. At step 150, a user becomes a member of multiple team rooms. The step of becoming a member of each given team room includes a grant of access to the team room and all the resources it contains. For example, a user that becomes a member of a team room may be added to one or more access control lists that describe the members of the team room, and that ensure that only members are permitted to access any of the team room contents. At step 152, the user enters one of the multiple team rooms to which the user belongs, and a user interface is generated for that team room that includes visual representations of all the team rooms to which the user belongs. At step 154, server software associated with each team room to which the user belongs provides awareness information in real time regarding the state of all team rooms to which the user belongs to the client software executing on the user's computer system. The awareness information provided at step 154 includes indications of whether any members are present in each team room, how many team room members are present in each team room, how many new documents there are in each team room, how many modified documents there are in each team room, what on-line discussions or other synchronous interaction are currently taking place in each team room, what tasks members are currently engaged in within each team room, and the like. Accordingly, in addition to acting as a repository for persistently storing team room contents, such as artifacts and tasks, the team room server software provides the notification functionality used to support synchronous notifications of changes occurring in team rooms, including members coming and going, tasks and artifacts being added, modified, or deleted, members switching from one task to another, and so on.

Based on the awareness information provided at step 154, at step 156 the client software on the user's computer system updates visual representations of the team rooms to which the user belongs as the awareness information is received from the server team room software, and reflecting the contents of the user's importance profile. Thus the notification functionality in the server team room software allows the client software to update a user interface construct such as the space bars of FIGS. 2 and 3 in real-time with up-to-date information about the team rooms to which the user belongs. In addition, the importance profile information maintained for the user on either the client system or the server system enables the client software to present awareness information to the user in a way that highlights changes or activities relating to relatively more important documents and/or tasks.

The disclosed system provides a number of advantages over existing team room solutions. First, unlike using email or polling-based RSS feeds to make members aware of team room changes and status, the disclosed system makes members aware of team room changes and status in real-time. Email and RSS are generally “pull” mechanisms, since a user must explicitly “check email” or “read an RSS feed” to obtain information, by which time the awareness data is as old as the messages that were sent or published. In contrast, the disclosed system supports real time notifications (i.e. “push” functionality) from team room server software, that are provided immediately upon the occurrence of a team room change. As a result, a user will see up-to-date information immediately through the user interface, without having to visit each team room.

In addition, using the disclosed system, users can easily maintain an awareness of all their team rooms at once. For example, users of the disclosed system are able to conveniently determine how many people are in each team room, and how many new and modified documents there are at any given time. This up-to-the-minute information is likely to lead users to make better decisions about when to visit their various team rooms.

Further, while techniques such as email or RSS typically require a user to leave the team room application for another application (i.e. the email client or RSS reader), the disclosed system does not require a user to leave the team room application—or even their current team room user interface—to see the status of other team rooms to which they belong.

Moreover, while the above description is focused on providing awareness information to a member of multiple team rooms, the disclosed system may alternatively be embodied as a technique for monitoring the status of other online activities in which a user participates. For example, in one such alternative embodiment involving online, multiplayer games, a user may be provided a user interface for an online game that includes visual representations of multiple games in which the user is participating. Such visual representations of games would be updated in real time to indicate status information regarding each game such as whether or not any other players are currently playing the game, how many other players are playing the game, whether any players that are important to the user are playing the game, how many important players are playing, etc.

The figures include block diagram and flowchart illustrations of methods, apparatus(s) and computer program products according to an embodiment of the invention. It will be understood that each block in such figures, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative graphical user interface constructs, one skilled in the art will recognize that they may be embodied using a variety of other alternative graphical user interfaces.

We claim:

1. A method of providing synchronous awareness of multiple team rooms to a member of said multiple team rooms, comprising:
conveying awareness information regarding each of said multiple team rooms in real time to a client application executing on a client computer system of said member of said multiple team rooms, wherein said awareness information includes indications of whether any team room members are currently present in each of said multiple team rooms; and
generating a user interface on said client computer system, wherein said user interface simultaneously displays a plurality of team room visual representations, each of said team room visual representations representing one of said multiple team rooms, wherein each of said team room visual representations of said multiple team rooms dynamically changes its visual appearance in real time to indicate whether one or more team room members are currently present in a team room represented by said team room visual representation.

2. The method of claim 1, further comprising:
generating a graphical user interface element proximate to a given one of said team room visual representations, wherein said graphical user interface element displays at least one detail regarding a current state of a team room represented by said given one said team room visual representations.

3. The method of claim 2, wherein said at least one detail comprises a number of team room members that are currently present in said one of said team rooms represented by said given one of said team room visual representations.

4. The method of claim 2, wherein said at least one detail comprises a number of new documents that are currently present in said one of said team rooms represented by said given one of said team room visual representations.

5. The method of claim 4, wherein said at least one detail further comprises a number of said new documents that are important to said member of said multiple team rooms.

6. The method of claim 2, wherein said at least one detail further comprises a number of modified documents that are currently present in said one of said team rooms represented by said given one of said team room visual representations.

7. The method of claim 6, wherein said at least detail further comprises a number of said modified documents that are important to said member of said multiple team rooms.

8. The method of claim 2, wherein said at least one detail further comprises an indication of a number of synchronous communication sessions currently underway in said one of said team rooms represented by said given one of said team room visual representations.

9. The method of claim 2, wherein said at least one detail further comprises an indication of a number of new tasks in said one of said team rooms represented by said given one of said team room visual representations.

10. The method of claim 8, wherein said number of synchronous communication sessions are determined to be important to said member of said multiple team rooms, and wherein said indication of said number of synchronous communication sessions further indicates that said number of synchronous communication sessions are important to said member of said multiple team rooms.

11. The method of claim 9, wherein said number of new tasks are determined to be important to said member of said multiple team rooms, and wherein said indication of said number of new tasks further indicates that said number of new tasks are important to said member of said multiple team rooms.

12. The method of claim 2, wherein said at least one detail further comprises an indication of a number of modified tasks in said one of said team rooms represented by said given one of said team room visual representations.

13. The method of claim 12, wherein said number of modified tasks are determined to be important to said member of said multiple team rooms, and wherein said indication of said number of modified tasks further indicates that said number of modified tasks are important to said member of said multiple team rooms.

14. The method of claim 1, further comprising:
providing a visual indicator on a given one of said team room visual representations, wherein said visual indicator graphically represents the number of new documents in one of said team rooms represented by said given one of said team room visual representations that are important to the member of said multiple team rooms and the number of new documents in said one of said team rooms represented by said given one of said team room visual representations that are not important to said member of said multiple team rooms.

15. The method of claim 14, wherein said visual indicator comprises a first bar having a length representing said number of new documents in said one of said team rooms represented by said given one of said team room visual representations that are important to said member of said multiple team rooms, and a second bar having a length representing said number of new documents in said one of said team rooms represented by said given one of said team room visual representations that are not important to said member of said multiple team rooms.

16. The method of claim 1, further comprising:
providing a visual indicator on a given one of said team room visual representations, wherein said visual indicator graphically represents the number of modified documents in one of said team rooms represented by said given one of said team room visual representations that are important to the member of said multiple team rooms and the number of modified documents in said one of said team rooms represented by said given one of said team room visual representations that are not important to said member of said multiple team rooms.

17. The method of claim 16, wherein said visual indicator comprises a first bar having a length representing said number of modified documents in said one of said team rooms represented by said given one of said team room visual representations that are important to said member of said multiple team rooms, and a second bar having a length representing said number of modified documents in said one of said team rooms represented by said given one of said team room visual representations that are not important to said member of said multiple team rooms.

18. The method of claim 1, further comprising:
providing a visual indicator on a given one of said team room visual representations, wherein said visual indicator graphically represents the number of new tasks in one of said team rooms represented by said given one of said team room visual representations that are important to the member of said multiple team rooms and the number of new tasks in said one of said team rooms represented by said given one of said team room visual representations that are not important to said member of said multiple team rooms.

19. The method of claim 18, wherein said visual indicator comprises a first bar having a length representing said number of new tasks in said one of said team rooms represented by said given one of said team room visual representations that are important to said member of said multiple team rooms, and a second bar having a length representing said number of new tasks in said one of said team rooms represented by said given one of said team room visual representations that are not important to said member of said multiple team rooms.

20. The method of claim 1, further comprising:
providing a visual indicator on a given one of said team room visual representations, wherein said visual indicator graphically represents the number of modified tasks in one of said team rooms represented by said given one of said team room visual representations that are important to the member of said multiple team rooms and the number of modified tasks in said one of said team rooms represented by said given one of said team room visual representations that are not important to said member of said multiple team rooms.

21. The method of claim 20, wherein said visual indicator comprises a first bar having a length representing said number of modified tasks in said one of said team rooms represented by said given one of said team room visual representations that are important to said member of said multiple team rooms, and a second bar having a length representing said number of modified tasks in said one of said team rooms represented by said given one of said team room visual representations that are not important to said member of said multiple team rooms.

22. The method of claim 1, further comprising:
providing a visual indicator on a given one of said team room visual representations, wherein said visual indicator graphically represents the percentage of the total number of team members that are currently present in one of said team rooms represented by said given one of said team room visual representations.

23. The method of claim 22, wherein said visual indicator comprises a bar having a length representing said percentage of the total number of team members that are currently present in one of said team rooms represented by said given one of said team room visual representations.

24. The method of claim 1, wherein each of said team room visual representations of said multiple team rooms dynamically changes said visual appearance in real time to indicate whether one or more team room members are currently present in a team room represented by said team room visual representation such that said team room visual representation is in color when one or more team room members are currently present in said team room represented by said team room visual representation and such that said team room visual representation is in gray scale when no team room members are currently present in said team room represented by said team room visual representation.

25. The method of claim 2, wherein said graphical user interface element comprises a tool tip generated in response to a user dragging the cursor over said given one said team room visual representations.

26. The method of claim 1, wherein each of said team rooms comprises a multi-player, online game, and wherein said indications of whether any team room members are currently present in each of said multiple team rooms comprise indications of whether any players are currently playing each of said online games, wherein said plurality of team room visual representations each represent one of said online games, and wherein each of said team room visual representations dynamically changes its visual appearance in real time to indicate whether one or more players are currently playing one of said online games represented by said team room visual representation.

27. A system including a computer readable medium, said computer readable medium having program code stored thereon for providing synchronous awareness of multiple team rooms to a member of said multiple team rooms, said program code comprising:
program code for conveying awareness information regarding each of said multiple team rooms in real time to a client application executing on a client computer system of said member of said multiple team rooms, wherein said awareness information includes indications of whether any team room members are currently present in each of said multiple team rooms; and
program code for generating a user interface on said client computer system, wherein said user interface simultaneously displays a plurality of team room visual representations, each of said team room visual representations representing one of said multiple team rooms, wherein each of said team room visual representations of said multiple team rooms dynamically changes its visual appearance in real time to indicate whether one or more team room members are currently present in a team room represented by said team room visual representation.

28. A computer program product including a computer readable medium, said computer readable medium having program code stored thereon for providing synchronous awareness of multiple team rooms to a member of said multiple team rooms, said program code comprising:
program code for conveying awareness information regarding each of said multiple team rooms in real time to a client application executing on a client computer system of said member of said multiple team rooms, wherein said awareness information includes indications of whether any team room members are currently present in each of said multiple team rooms; and
program code for generating a user interface on said client computer system, wherein said user interface simultaneously displays a plurality of team room visual representations, each of said team room visual representations representing one of said multiple team rooms, wherein each of said team room visual representations of said multiple team rooms dynamically changes its visual appearance in real time to indicate whether one or more team room members are currently present in a team room represented by said team room visual representation.

29. A computer data signal embodied in a carrier wave, said computer data signal having program code stored thereon for providing synchronous awareness of multiple team rooms to a member of said multiple team rooms, said program code comprising:
program code for conveying awareness information regarding each of said multiple team rooms in real time to a client application executing on a client computer system of said member of said multiple team rooms, wherein said awareness information includes indications of whether any team room members are currently present in each of said multiple team rooms; and
program code for generating a user interface on said client computer system, wherein said user interface simultaneously displays a plurality of team room visual representations, each of said team room visual representations representing one of said multiple team rooms, wherein each of said team room visual representations of said multiple team rooms dynamically changes its visual appearance in real time to indicate whether one or more team room members are currently present in a team room represented by said team room visual representation.

30. A system for providing synchronous awareness of multiple team rooms to a member of said multiple team rooms, comprising:
means for conveying awareness information regarding each of said multiple team rooms in real time to a client application executing on a client computer system of said member of said multiple team rooms, wherein said awareness information includes indications of whether any team room members are currently present in each of said multiple team rooms; and
means for generating a user interface on said client computer system, wherein said user interface simultaneously displays a plurality of team room visual representations, each of said team room visual representations representing one of said multiple team rooms, wherein each of said team room visual representations of said multiple team rooms dynamically changes its visual appearance in real time to indicate whether one or more team room members are currently present in a team room represented by said team room visual representation.
